(19) United States
(12) Patent Application Publication
(10) Pub. No.: US 2024/0159106 A1
(43) Pub. Date: May 16, 2024

(54) SLIDE OUT PUMP STAND FOR HYDRAULIC FRACTURING EQUIPMENT

(71) Applicant: U.S. Well Services, LLC, Houston, TX (US)

(72) Inventors: Jared Oehring, Houston, TX (US); Brandon Neil Hinderliter, Houston, TX (US)

(73) Assignee: U.S. Well Services, LLC, Houston, TX (US)

(21) Appl. No.: 18/208,931

(22) Filed: Jun. 13, 2023

Related U.S. Application Data
(63) Continuation of application No. 16/564,186, filed on Sep. 9, 2019, now Pat. No. 11,674,352.
Application No. 16/564,186 is a continuation of application No. 15/217,081, filed on Jul. 22, 2016, now Pat. No. 10,407,990.
(60) Provisional application No. 62/196,525, filed on Jul. 24, 2015.

(51) Int. Cl. E21B 7/02

(52) U.S. Cl. CPC E21B 7/02; E21B 7/022; E21B 7/026; F04B 47/02

(57) ABSTRACT

A hydraulic fracturing system has a pump driven by an electrically powered motor. The pump pressurizes fluid which is piped into a wellbore to fracture a subterranean formation. The pump and motor are mounted on a trailer that is hitched to a tractor. A platform assembly is mounted onto the trailer, and which is selectively moveable between deployed and stowed configurations. The platform assembly includes a platform, a lateral rail assembly mounted to the platform, and gates on the forward and aft ends of the platform. The rail assembly and gates define a safety barrier to prevent operations personnel from falling off the platform. In the stowed configuration the platform assembly is anchored in place over wheels on the trailer. In the deployed configuration, the platform assembly provides work surface so that operations personnel can readily access the pump on the trailer.

### CROSS REFERENCE TO RELATED APPLICATIONS

This application is a continuation of U.S. patent application Ser. No. 16/564,186, filed Sep. 9, 2019, titled “SLIDE OUT PUMP STAND FOR HYDRAULIC FRACTURING EQUIPMENT,” now U.S. Pat. No. 11,674,352, issued Jun. 13, 2023, which is a continuation of U.S. patent application Ser. No. 15/217,081, filed Jul. 22, 2016, titled “SLIDE OUT PUMP STAND FOR HYDRAULIC FRACTURING EQUIPMENT,” now U.S. Pat. No. 10,407,990, issued Sep. 10, 2019, which claims priority to and the benefit of U.S. Provisional Application Ser. No. 62/196,525, filed Jul. 24, 2015, the full disclosures of which are hereby incorporated by reference herein for all intents and purposes.

### BACKGROUND OF THE INVENTION

### 1. Field of Invention

The present disclosure relates to a system for hydraulically fracturing a subterranean formation. More specifically, the present disclosure relates to a frame for hydraulic fracturing equipment that includes a retractable platform.

### 2. Description of Prior Art

Hydraulic fracturing is a technique used to stimulate production from some hydrocarbon producing wells. The technique usually involves injecting fluid into a wellbore at a pressure sufficient to generate fissures in the formation surrounding the wellbore. Typically the pressurized fluid is injected into a portion of the wellbore that is pressure isolated from the remaining length of the wellbore so that fracturing is limited to a designated portion of the formation. The fracturing fluid, whose primary component is usually water, includes proppant (such as sand or ceramic) that migrate into the fractures with the fracturing fluid and remain to prop open the fractures after pressure is no longer applied to the wellbore.

The fracturing fluid is usually pressurized on surface by high pressure pumps powered by diesel engines. To produce the pressures required for hydraulic fracturing, the pumps and associated engines have substantial volume and mass. Heavy duty trailers are required for transporting the large and heavy pumps and engines to sites where wellbores are being fractured. Each pump is usually equipped with a water manifold (referred to as a fluid end) which contains seats, valves, and keepers internally. These parts allow the pump to draw in low pressure fluid (approximately 100 psi) and discharge the same fluid at high pressures (over 10,000 psi). These seats and valves often erode due to the proppant in the fracturing fluid; which sometimes requires frequent replacement. Replacing the eroded components can be hazardous as the fluid ends are typically above grade on mobile trailers, and which generally have limited space on which maintenance personnel can stand. The height hazard is compounded by the use of heavy pump tools for assembly and disassembly of the fluid end for part replacement.

### SUMMARY OF THE INVENTION

Disclosed herein is an example of a hydraulic fracturing system for fracturing a subterranean formation and which includes a plurality of electric pumps fluidly connected to the formation, and powered by at least one electric motor, and configured to pump fluid at high pressure into a wellbore that intersects the formation, so that the fluid passes from the wellbore into the formation, and fractures the formation, a variable frequency drive connected to the electric motor to control the speed of the motor, wherein the variable frequency drive frequently performs electric motor diagnostics to prevent damage to the at least one electric motor, a trailer on which the motor and pumps are mounted, and a platform assembly mounted to the trailer and from which at least a one of the pumps are accessible by operations personnel. The platform assembly can be selectively moveable between a stowed configuration and spaced laterally inward from an outer periphery of wheels coupled with the trailer, to a deployed configuration and spaced laterally past an outer periphery of the wheels. In one example, support rails are mounted to the platform assembly that slidingly engage mount assemblies that are coupled to the trailer. Bores are optionally formed in the support rails register with holes in the mount assemblies when the platform assembly is in the stowed configuration, and wherein a pin selectively inserts through the bores and holes to anchor the platform assembly in the stowed configuration. Rollers may optionally be included in the mount assemblies that rotate when the support rails slidingly engage the mount assemblies. In an example, the platform assembly includes a lateral rail assembly on a side that is distal from the pump. Further included in this example embodiment are end gates on forward and aft ends of the platform assembly that are pivotingly mounted on opposing axial ends of the lateral rail assembly. The end gates can swing into orientations that are substantially perpendicular with the lateral rail assembly when the platform assembly is moved into a deployed configuration. In one embodiment, a pair of motors are first and second motors, and a pair of pumps are first and second pumps, wherein the first and second pumps and motors are mounted on the trailer, wherein the first motor is coupled to and drives the first pump, and wherein the second motor is coupled to and drives the second pump.

Also described herein is a hydraulic fracturing system for fracturing a subterranean formation and that includes a trailer, a pump on the trailer that selectively pressurizes fracturing fluid, an electrically powered motor that drives the pump, a variable frequency drive in electrical communication with the motor, and a platform assembly coupled with the trailer and that is adjacent the pump so that when operations personnel are on the platform assembly, locations on the pump are accessible by the operations personnel. In one example, the platform assembly is stowed so that an outer lateral side of the platform assembly is set laterally inward from an outer edge of wheels that are mounted to the trailer. The platform assembly can be moveable from being stowed into a deployed configuration where the platform assembly projects laterally past the wheels. In one embodiment, the platform assembly includes a lateral rail assembly, a forward gate, and an aft gate and which define a safety barrier for operations personnel on the platform assembly. The gates can each have a lateral side that is affixed by a hinge to the lateral rail assembly and on opposite sides, the hinge can be made up of a vertically oriented pin and spring, wherein the spring swings free ends of the gates away from the lateral rail assembly when the platform assembly is changed from a stowed configuration to a deployed configuration. Elastomeric bungees can be included that each having an end affixed to the lateral rail assembly, and free ends that selectively insert into slotted clips affixed to inner frames on the gates. Stop members can be included on the gates that mount to inner frames on the gates and abut the pins when the gates rotate to positions that are substantially perpendicular with the lateral rail assembly. In one embodiment, the platform assembly includes a platform with a deck and frame, support rails that coupled to the platform, and mounting assemblies attached to a frame of the trailer and which slidingly receive the support rails.

### BRIEF DESCRIPTION OF DRAWINGS

Some of the features and benefits of the present invention having been stated, others will become apparent as the description proceeds when taken in conjunction with the accompanying drawings, in which:

FIG. 1 is a perspective view of an example of a trailerized pump system.

FIG. 2 is an end view of an example of a platform assembly for use with the trailerized pump system of FIG. 1 and in a deployed configuration.

FIG. 3 is an end view of an example of a platform assembly for use with the trailerized pump system of FIG. 1 and in a stowed configuration.

FIG. 4 is a perspective view of an example of a gate that is part of the platform assemblies of FIGS. 2 and 3.

FIG. 5 is a schematic example of a hydraulic fracturing system.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout. In an embodiment, usage of the term “about” includes +/−5% of the cited magnitude. In an embodiment, usage of the term “substantially” includes +/−5% of the cited magnitude.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

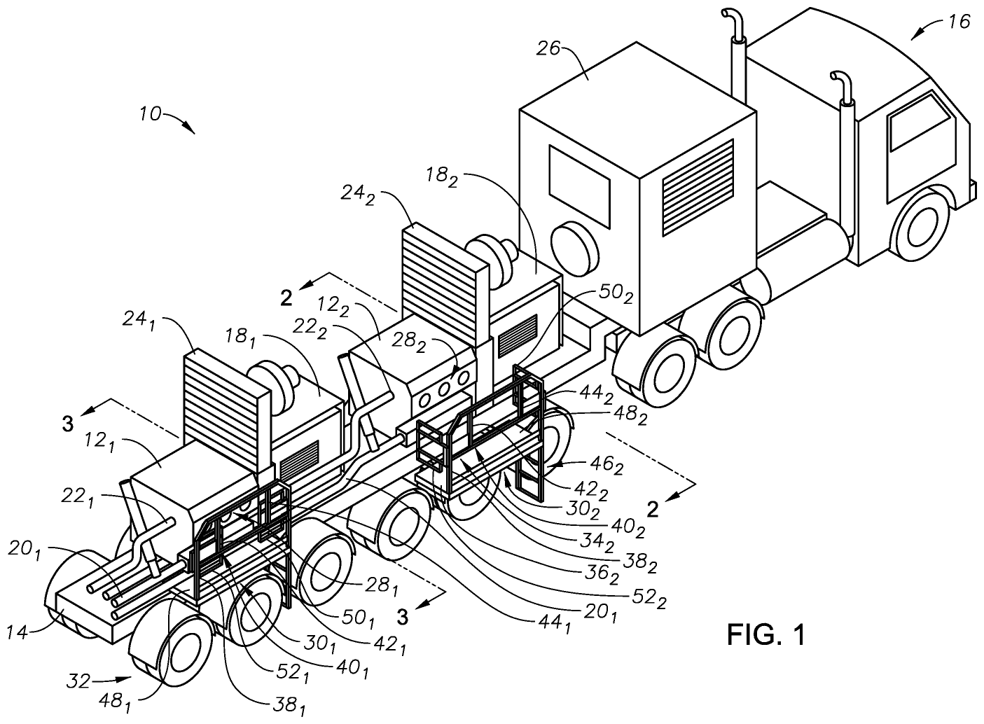

Shown in a side perspective view in FIG. 1 is one example of a trailerized pump system 10 which is shown having pumps 12₁, 12₂ mounted on a trailer 14. As described in more detail below, pumps 12₁, 12₂ pressurize fracturing fluid that is then delivered into a wellbore for fracturing a formation. In the illustrated example, the pumps 12₁, 12₂ are mounted on the trailer 14; where trailer 14 couples with a tractor 16 for transporting the trailer 14 and pumps 12₁, 12₂ to different locations. Also mounted on trailer 14 are motors 18₁, 18₂ which are used for driving pumps 12₁, 12₂ and which are electrically powered. Suction piping leads 20₁, 20₂ respectively couple to a suction side of pumps 12₁, 12₂ and which provide the fracturing fluid to pumps 12₁, 12₂. Similarly, discharge piping leads 22₁, 22₂ transfer the fluid pressurized by pumps 12₁, 12₂ to their destination. Radiators 24₁, 24₂ are further shown on trailer 14 and are provided for cooling hydraulic fluids associated with the pumps 12₁, 12₂ and motors 18₁, 18₂. A control room 26 is depicted at a forward end of trailer 14 proximate tractor 16, and which houses various controls and monitoring displays (not shown) for operating devices located within system 10.

Mounted on a side of pumps 12₁, 12₂ facing the lateral side of trailer 14 are cover plate sets 28₁, 28₂, which when removed provide access to various components within pumps 12₁, 12₂ that require regular maintenance as well as repair and replacement. Example components include seals, valves, seats, and keepers (not shown). Accordingly, platform assemblies 30₁, 30₂ are shown provided with trailer 14 and which can selectively be deployed so that operations personnel can access the pumps 12₁, 12₂ and remove cover plate sets 28₁, 28₂ for repairing pumps 12₁, 12₂. More specifically, platform assembly 30₁ is shown in a stowed position and proximate a lateral side of trailer 14, whereas platform assembly 30₂ is shown in a deployed configuration and slid laterally outward from the lateral edge of trailer 14. When in the stowed configuration, platform assembly 30₁ is set above wheels 32 that are mounted onto trailer 14. The platform assemblies 30₁, 30₂ are strategically formed so that when they are each in the stowed position their outer lateral peripheries terminate within the outer edge of wheels 32. Thus when in the stowed position, the platform assemblies 30₁, 30₂ are set laterally inward from the outer edge of the wheels 32, which prevents interference between the platform assemblies 30₁, 30₂ and other objects when the system 10 is in transit.

Referring now to FIGS. 1, 2, and 3, lateral rail assembly 34₁, 34₂ are respectively provided on platform assemblies 30₁, 30₂. Lateral rail assemblies 34₁, 34₂ are transversely mounted on a platform 36 that is generally parallel with an upper surface of trailer 14. A frame 38₁, 38₂, which makes up a part of the lateral rail assemblies 34₁, 34₂, is a generally U-shaped member and having either a circular or rectangular cross-section. Opposing ends of frame 38₁, 38₂, mount onto corners of the platform 36 distal from its coupling with trailer 14. Mid-beams 40₁, 40₂ are shown extending between vertically disposed portions of frame 38₁, 38₂. Balusters 44₁, 44₂ are illustrated that vertically span the distance between mid-beams 40₁, 40₂ and upper longitudinally extending portions of frames 38₁, 38₂. A forward end of each of the platform assemblies 30₁, 30₂ includes a ladder assembly 46₁, 46₂ which provides rungs and side rails on which operations personnel can climb onto platform 36₁, 36₂. Each platform 36₁, 36₂ includes a deck 48₁, 48₂ which extends in generally the same plane as platform 36₁, 36₂. Each deck 48₁, 48₂ may optionally be solid, or formed from a grated material with openings therethrough so that liquids and other slippery substances can fall therethrough and avoid a slick surface for operations personnel working on platforms 36₁, 36₂. In an embodiment, the platform assemblies 30₁, 30₂ are strategically formed so that operations personnel on the platform assemblies 30₁, 30₂ can access a coupler (not shown) between the pumps 12₁, 12₂, and motors 18₁, 18₂.

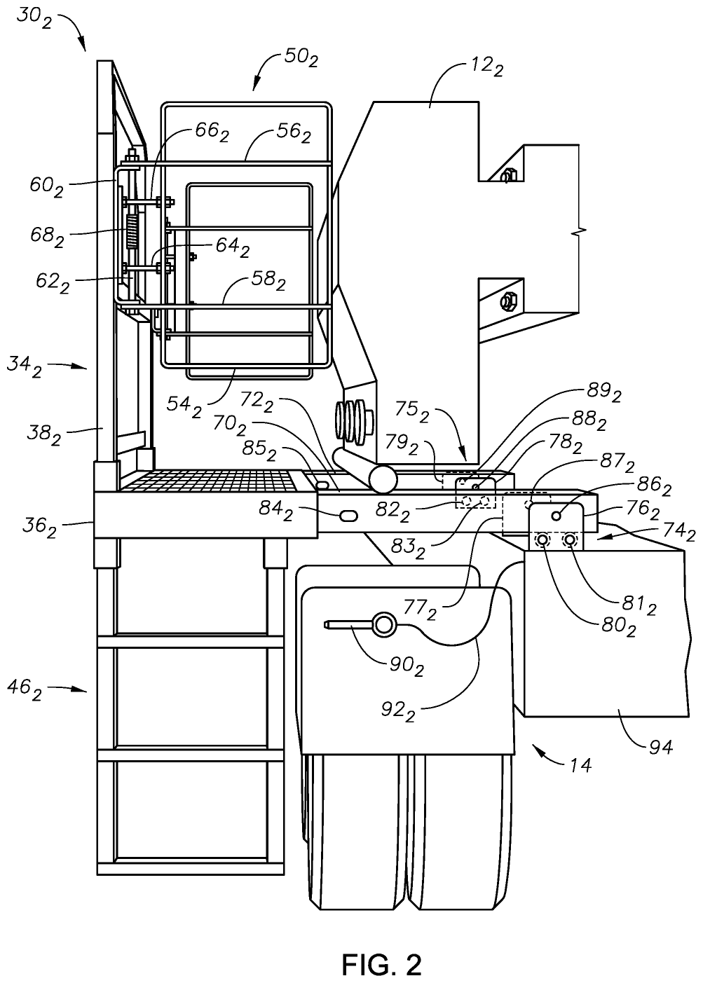

Forward ends of the platform assemblies 30₁, 30₂ are fitted with forward gates 50₁, 50₂ that selectively pivot respectively from the forward ends frames 38₁, 38₂ and provide a safety barrier to prevent operations personnel from accidentally falling from platforms 36₁, 36₂. However, because the gates 50₁, 50₂, 52₁, 52₂ are pivotally mounted, they can be rotated back against the frames so that operations personnel can access or leave the platform assemblies 30₁, 30₂. Similarly, aft gates 52₁, 52₂ are provided on ends of frame 38₁, 38₂ distal from forward gates 50₁, 50₂. Referring now to FIG. 2, which is taken along lines 2-2 of FIG. 1, shown in side view is an example of forward gate 50₂, and which includes an outer frame 54₂, which is a generally elongate member and fashioned into a rectangular shape. Provided with the outer frame 54₂ are longitudinally extending arms 56₂, 58₂ that are vertically spaced apart from one another, and project between the vertical portions of the member of outer frame 54₂. Ends of the arms 56₂, 58₂ couple onto a mounting bracket 60₂ which mounts to a vertical portion of frame 38₂. A vertically oriented rod 62₂ projects through holes formed in ends of arms 56₂, 58₂. The holes in the ends of arms 56₂, 58₂ register with holes bored in horizontally disposed sections of the mounting bracket 60₂. Rod 62₂ projects through holes in arms 56₂, 58₂ and in bracket 60₂ thereby pivotally coupling together the forward gate 50₂ and frame 38₂. Stop members 64₂, 66₂ also couple into a vertical section of outer frame 54₂ and abut a panel mounted to frame 38₂ thereby limiting the rotational motion of the forward gate 50₂. A spring 68₂ circumscribes a portion of the rod 62₂ and when the platform assembly 30₂ is moved into the deployed position as shown in FIG. 2, the spring 68₂ pivotingly urges the forward gate 50₂ away from frame 38₂. Aft gate 52₂, which is substantially similar to forward gate 50₂, also includes a spring that causes aft gate 52₂ to pivotingly swing aft gate 52₂ away from frame 38₂. Thus the combination of gates 50₂, 52₂ and frame 38₂ define a safety barrier for operations personnel disposed on the deck 48₂ and prevents operations personnel from falling from platform 36₂.

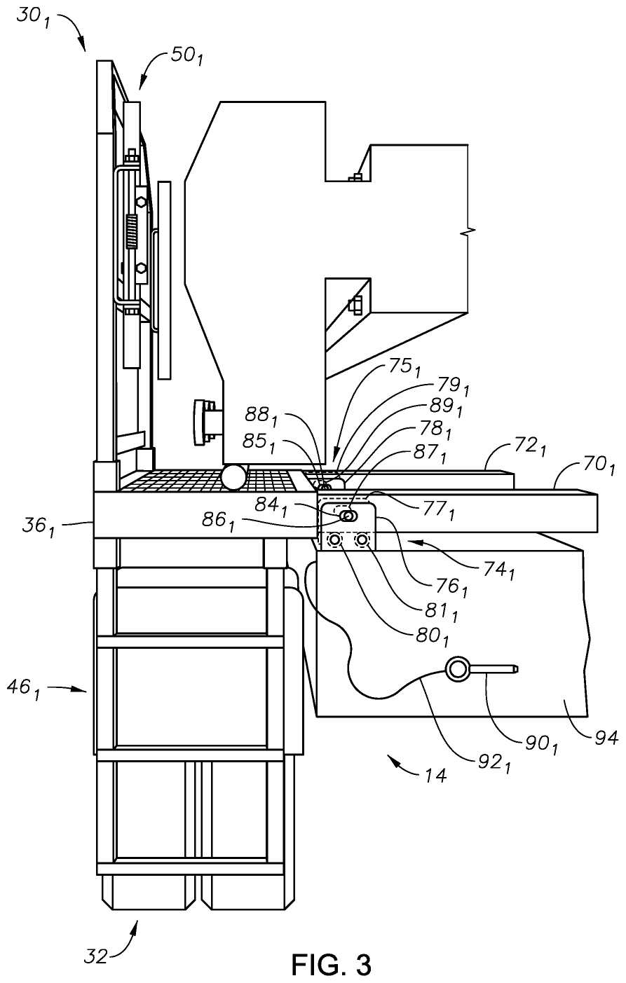

Referring now to FIGS. 2 and 3, support rails 70_{1,2}, 72_{1,2} are shown which are generally elongate members that are horizontally disposed, and project laterally inward from platforms 36₁, 36₂. More specifically, support rails 70₁, 72₁ are coupled with platform 36₁, and support rails 70₂, 72₂ are coupled with platform 36₂. Support rails 70₁, 72₁ slidingly engage mount assemblies 74₁, 75₁ respectively, and support rails 70₂, 72₂ slidingly engage mount assemblies 74₂, 75₂ respectively. Mount assembly 74₁ is made up of a pair of vertically disposed lateral plates 76₁, 77₁ that are substantially parallel with one another and axially spaced apart. Similarly, mount assembly 74₂ is made up of a pair of vertically disposed lateral plates 76₂, 77₂ that are also substantially parallel with one another and axially spaced apart. Support rail 70₁ engages mount assembly 74₁ between plates 76₂, 77₂. Further, mount assembly 75₁ is made up of a pair of vertically disposed and parallel lateral plates 78₁, 79₁; and mount assembly 75₂ includes lateral plates 78₂, 79₂ that are also substantially parallel with one another and axially spaced apart. Rollers 80₁, 81₁ span between lateral plates 76₁, 77₁ and which support rail 70₁ as it slidingly reciprocates with respect to mount assembly 74₁. Rollers 80₂, 81₂ connected between lateral plates 76₂, 77₂ provide rolling support for rail 71₂, rollers (not shown) extend between lateral plates 78₁, 79₁ which bolster support rail 72₁, and rollers 82₂, 83₂ are anchored across lateral plates 78₂, 79₂ to provide rolling support for support rail 72₂.

The sliding engagement of the support rails 70_{1,2}, 72_{1,2} with the mount assemblies 74_{1,2}, 75_{1,2} allows the platform assemblies 30₁, 30₂ to be readily moved between the stowed and deployed configurations of FIG. 2. Further, rollers or other structure (not shown) slidingly contacts an upper surface of rails 70_{1,2}, 72_{1,2} which maintains the rails 70_{1,2}, 72_{1,2} in a generally horizontal orientation so that the decks 48₁, 48₂ remain substantially horizontal when the platform assemblies 30₁, 30₂ are deployed and when stowed. Bores 84_{1,2}, 85_{1,2} are shown formed axially through the support rails 70_{1,2}, 72_{1,2}, and that selective register with holes 86_{1,2}, 87_{1,2}, 88_{1,2}, 89_{1,2}, formed through the lateral plates 76_{1,2}, 77_{1,2}, 78_{1,2}, 79_{1,2}, allow pins 901,2 to be inserted therethrough thereby locking support rails 70_{1,2}, 72_{1,2}, to the mount assemblies 74_{1,2}, 75_{1,2} and thereby coupling and securing the platform assemblies 30₁, 30₂ to the trailer 14. Lanyards 92_{1,2} are shown holding pins 90_{1,2} to the trailer frame 94.

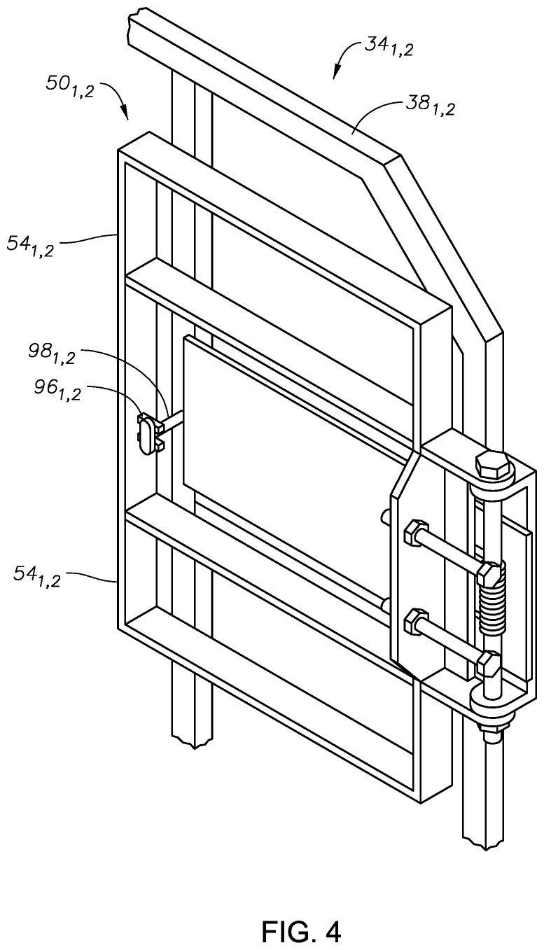

Referring now to FIG. 4, in this example gates 50_{1,2} are shown in the retracted position with their outer frames 54_{1,2} adjacent to and parallel with the frames 38_{1,2} of the rail assemblies 34_{1,2}. In this example, slotted clips 96_{1,2} are provided on the frames 54_{1,2} and in which enlarged ends of bungees 98_{1,2} selectively are inserted into the clips 96_{1,2} which retain the gates 50_{1,2} against the frames 38_{1,2} when the platform assemblies 30₁, 30₂ (FIG. 1) are in their retracted or stowed positions. In an embodiment, bungees 98_{1,2} are formed from an elastomeric material.

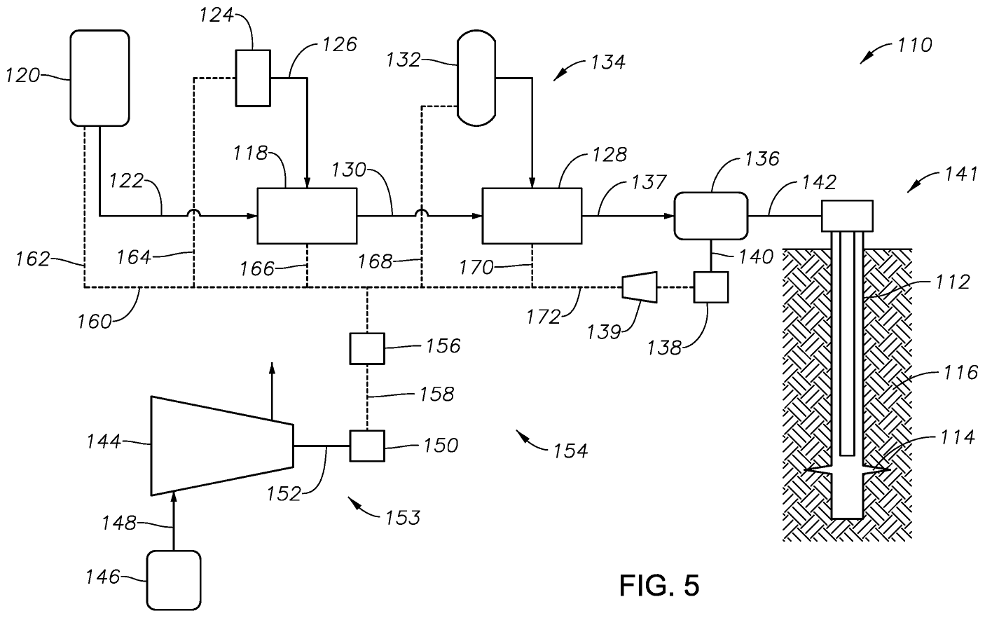

FIG. 5 is a schematic example of a hydraulic fracturing system 110 that is used for pressurizing a wellbore 112 to create fractures 114 in a subterranean formation 116 that surrounds the wellbore 112. Included with the system 110 is a hydration unit 118 that receives fluid from a fluid source 120 via line 122, and also selectively receives additives from an additive source 124 via line 126. Additive source 124 can be separate from the hydration unit 118 as a stand along unit, or can be included as part of the same unit as the hydration unit 118. The fluid, which in one example is water, is mixed inside of the hydration unit 118 with the additives. In an embodiment, the fluid and additives are mixed over a period of time to allow for uniform distribution of the additives within the fluid. In the example of FIG. 5, the fluid and additive mixture is transferred to a blender 128 via line 130. A proppant source 132 contains proppant, which is delivered to the blender 128 as represented by line 134, where line 134 can be a conveyer. Inside the blender 128, the proppant and fluid/additive mixture are combined to form a slurry, which is then transferred to a fracturing pump 136 via line 137. Blender 128 can have an onboard chemical additive system, such as with chemical pumps and augers. Optionally, additive source 124 can provide chemicals to blender 128; or a separate and standalone chemical additive system (not shown) can be provided for delivering chemicals to the blender 128. In an example, the pressure of the slurry in line 137 ranges from around 80 psi to around 100 psi. The pressure of the slurry can be increased up to around 15,000 psi by pump 136. A motor 138, which connects to pump 136 via shaft 140, drives pump 136 so that it can pressurize the slurry. In one example, the motor 138 is controlled by a variable frequency drive (“VFD”) 139. After being discharged from pump 136, slurry is injected into a wellhead assembly 141; discharge piping 142 connects discharge of pump 136 with wellhead assembly 141 and provides a conduit for the slurry between the pump 136 and the wellhead assembly 141. In an alternative, hoses or other connections can be used to provide a conduit for the slurry between the pump 136 and the wellhead assembly 141. Optionally, any type of fluid can be pressurized by the fracturing pump 136 to form an injection fluid that is then injected into the wellbore 112 for fracturing the formation 114, and is not limited to fluids having chemicals or proppant. In one example, a one or more of the trailerized pump systems 10 of FIG. 1 is made up of the fracturing pump 136, motor 138, and VFD 139.

An example of a turbine 144 is provided in the example of FIG. 1 and which receives a combustible fuel from a fuel source 146 via a feed line 148. In one example, the combustible fuel is natural gas, and the fuel source 146 can be a container of natural gas or a well (not shown) proximate the turbine 144. Combustion of the fuel in the turbine 144 in turn powers a generator 150 that produces electricity. Shaft 152 connects generator 150 to turbine 144. The combination of the turbine 144, generator 150, and shaft 152 define a turbine generator 153. In another example, gearing can also be used to connect the turbine 144 and generator 150. An example of a micro-grid 154 is further illustrated in FIG. 5, and which distributes electricity generated by the turbine generator 153. Included with the micro-grid 154 is a transformer 156 for stepping down voltage of the electricity generated by the generator 150 to a voltage more compatible for use by electrical powered devices in the hydraulic fracturing system 110. In another example, the power generator by the turbine generator 153 and the power utilized by the electrical powered devices in the hydraulic fracturing system 110 are of the same voltage, such as 4160 V so that main power transformers are not needed. In one embodiment, multiple 3500 kVA dry cast coil transformers are utilized. Electricity generated in generator 150 is conveyed to transformer 156 via line 158. In one example, transformer 156 steps the voltage down from 13.8 kV to around 600 V. Other step down voltages can include 4,160 V, 600V, 480 V, or other voltages. The output or low voltage side of the transformer 156 connects to a power bus 160, lines 162, 164, 166, 168, 170, and 172 connect to power bus 160 and deliver electricity to electrically powered end users in the system 110. More specifically, line 162 connects fluid source 120 to bus 160, line 164 connects additive source 124 to bus, line 166 connects hydration unit 118 to bus 160, line 168 connects proppant source 132 to bus 160, line 170 connects blender 128 to bus 160, and line 172 connects motor 138 to bus 160. In an example, additive source 124 contains ten or more chemical pumps for supplementing the existing chemical pumps on the hydration unit 118 and blender 128. Chemicals from the additive source 124 can be delivered via lines 126 to either the hydration unit 118 and/or the blender 128.

An advantage of the micro-grid 54 is that it can reduce noise. Further, in conjunction with the micro-grid 154, when multiple fracturing pump systems 10 are employed, the pumps 136 can be arranged along a single side of the system 110 to create one high voltage area. Optionally, generators other than turbine generators can be included in the system 110, such as diesel engine generators or natural gas engine generators. In an example when the combustion fuel is natural gas, electric natural gas screw compressors can be included that operate on 480 V delivered from small transformers on the turbine—which can provide 480 power for the turbine motor control center (not shown) as well as the gas compressors. In an alternative example, the power generation can take place at a remote site with power being transmitted to the well pad. In one embodiment load banks can be incorporated into the micro grid. Load shed devices can be incorporated into the micro grid, as well as cooling units for the turbine air intake. Switchgears for power distribution can be included, and that may be trailer mounted, on a skid, or truck. Optionally included are 3500 kVA transformers to transform power from 13.8 kV to 600 V (working voltage), but can be other voltages. An auxiliary unit (not shown) can be included with the system 110 and which provides power for blender unit 128, hydration unit 118, chemical additive/liquid unit, sand conveyer belt, dust vacuum system, wireline, data van, water transfer, heaters, and other needed electrical connections on one or more voltages to the mobile micro power grid. In one embodiment, each auxiliary unit includes, 3500 kVA transformer, variable frequency drive for blender discharge pump's electric motor, 1750 HP, 600 V, 1700 amp 6 pulse VFD. For each VFD, a six pulse converter section employs diode bridge rectification to convert AC to DC. Converter section is unaffected by phase rotation/phase sequence. Overall DC bus design is passive capacitive filter to minimize ripple and maximize power-loss ride-through. DC bus capacitance (total filter capacitance) can be used that is sized to eliminate any requirement for bus inductance (for filtering purposes) when used on a 3-phase system. DC Bus voltage and current can be monitored by a control section to prevent damage to either the drive or the driven equipment. An inverter section makes use of the insulated gate bipolar transistor (“IGBT”) power switching transistors to convert DC to three-phase, variable frequency, sinusoidal coded Pulse Wide Modulation (“PWM”) waveform. IGBT initialization testing can be performed by the control section on each power up and run command. Each IGBT can have reversed biased diodes (freewheeling) to prevent failure when subjected to motor discharge spikes. Each IGBT can be sized (current) to allow the drive to operate at 100% (current) continuous and 120% (current) for up to 60 seconds. Output currents in each phase can be monitored using Hall Effect current transducers to enable control of flux current, torque current, and providing protection to both the drive and driven equipment. The inverter section can sense and interrupt a phase-to-phase or phase-to-ground fault on the output of the drive. In an example, the control section is designed to prove complete monitoring and protection of drive internal operations while communicating to users at the equipment or at the datavan through one or more user interfaces.

Microprocessor logic circuits can be isolated from power circuits. Microprocessor diagnostics can be performed (on application of power) to prove functionality and viability of the microprocessor. Motor diagnostics can be performed (on application of power and each start) to prevent damage to a grounded or shorted motor. The motor diagnostics may be disabled when using a low impedance or high-speed motor. The output voltage can be adjustable from 0 to rated input voltage. The output frequency range can be adjustable for a maximum frequency output of 299 Hz. The output (inverter) section of the VFD can produce a pulse width modulation (“PWM”) sinusoidal coded waveform. The motor control center can include soft start for blender hydraulics' electric motor with full voltage non-reversing and hand-off-auto switch. Soft start can be included for hydration units hydraulics' electric motor with full voltage non-reversing and hand-off-auto switch. In one example, as part of the micro grid, VFDs as described above can be used to control the speed of electric motors on frac pumps, blenders, water transfer, and other equipment as needed. In addition, soft starts can be used to start electric motors that are connected to blender, hydration, and/or chemical additive unit hydraulic systems and other equipment that does not need variable frequency drive or variable speed. A motor soft starter is a device used with AC electrical motors to temporarily reduce the load and torque in the power train and electric current surge of the motor during start-up. This reduces the mechanical stress on the motor and shaft, as well as the electrodynamic stresses on the attached power cables and electrical distribution network, extending the lifespan of the system. In one example a soft start and/or VFD can be provided for a separate chemical additive unit or other needed equipment. These components can be packaged onto a single unit or be separated and packaged on different units.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims.

What is claimed is:

1. A hydraulic fracturing system for fracturing a subterranean formation comprising:
a plurality of electric pumps fluidly connected to the formation, and powered by at least one electric motor;
a platform on which the motor and pumps are mounted;
a platform assembly from which at least a one of the pumps are accessible by operations personnel;
support rails mounted to the platform assembly;
further comprising end gates on forward and aft ends of the platform assembly; and
a trailer, wherein the support rails mounted to the platform assembly slidingly engage mount assemblies that are coupled to the trailer.
